(19) United States
(12) Patent Application Publication
(10) Pub. No.: US 2011/0292041 A1
(43) Pub. Date: Dec. 1, 2011

(54) STEREOSCOPIC DISPLAY APPARATUS AND METHOD OF DRIVING THE SAME

(75) Inventors: Ho-seop LEE, Seongnam-si (KR); Dae-sik KIM, Hwaseong-si (KR); Kyung-hoon CHA, Yongin-si (KR); Jong-hoon JUNG, Suwon-si (KR); Young-ji KO, Seoul (KR)

(73) Assignee: SAMSUNG ELECTRONICS CO., LTD., Suwon-si (KR)

(21) Appl. No.: 13/115,785

(22) Filed: May 25, 2011

Related U.S. Application Data
(60) Provisional application No. 61/347,969, filed on May 25, 2010.
(60) Provisional application No. 61/362,371, filed on Jul. 8, 2010.

(30) Foreign Application Priority Data
Nov. 30, 2010 (KR) 10-2010-0120610

(51) Int. Cl. G06T 15/00

(52) U.S. Cl. 345/419

(57) ABSTRACT

A stereoscopic display apparatus is provided. The display apparatus includes a display panel for scanning an image alternately at a first frame frequency and a second frame frequency, different from the first frame frequency, an image signal input unit for inputting an image signal to the display panel, a backlight unit for emitting light to the display panel, and a shutter controller for selectively controlling an opening and closing of a left eye shutter and a right eye shutter of shutter glasses.

### CROSS-REFERENCE TO RELATED PATENT APPLICATIONS

This is a non-provisional application of U.S. Provisional Application No. 61/347,969 filed May 25, 2010 and U.S. Provisional Application No. 61/362,371 filed Jul. 8, 2010, the disclosures of which are incorporated herein by reference in their entirety.

This application claims priority from Korean Patent Application No. 10-2010-0120610, filed on Nov. 30, 2010, in the Korean Intellectual Property Office, the disclosure of which is incorporated herein by reference in its entirety.

### BACKGROUND

1. Field

Apparatuses and methods consistent with exemplary embodiments relate to a stereoscopic display apparatus in which crosstalk is reduced or removed, and a method of driving the stereoscopic display apparatus.

2. Description of the Related Art

In general, a three dimensional (3-D) image may be perceived due to stereoscopic vision through a viewers left and right eyes. Binocular parallax, which is generated because a person's left and right eyes are separated about 65 mm from each other, may be regarded as the most important cause of the stereoscopic effect. The stereoscopic effect is achieved because each of the two eyes see a slightly different image. For this reason, to create a 3D image, a subject is photographed using two cameras of the same type which are separated from each other by the same distance as the distance between a viewer's left and right eyes. Then, an image generated by the left camera is provided only to a viewer's left eye and an image generated by the right camera is provided only to a viewer's right eye.

A stereoscopic display apparatus may be a glasses type display or a non-glasses type display. A glasses type display may be a polarized glasses type display or a shutter glasses type display. A non-glasses type display may be a parallax barrier type display, a lenticular type display, an integral imaging type display, or a holography type display.

A shutter glasses type display produces a stereoscopic image by using liquid crystal shutter glasses. The liquid crystal shutter glasses provide different images to the left eye and the right eye at a frequency of, for example, 120 Hz. A stereoscopic display apparatus using a liquid crystal shutter glasses type display alternately displays a left image and a right image and controls an opening and closing of a left liquid crystal shutter and a right liquid crystal shutter alternately in synchronization with the displaying of a left eye image and a right eye image.

However, in A glasses type 3-D display, a crosstalk phenomenon may occur in which a left eye image and a right eye image are mixed in a single frame. The crosstalk phenomenon may provide incorrect images to a viewer's left and right eyes, causing fatigue.

### SUMMARY

To solve the above and/or other problems, exemplary embodiments provide a stereoscopic display apparatus for displaying an image in which crosstalk is reduced or removed, and a method of driving the stereoscopic display apparatus.

According to an aspect of an exemplary embodiment, a stereoscopic display apparatus includes a display panel which scans images alternately at a first frame frequency and a second frame frequency, which is different from the first frame frequency, an image signal input unit which inputs an image signal to the display panel, a backlight unit which emits light to the display panel, and a shutter controller which controls an opening and closing of a left eye shutter and a right eye shutter of shutter glasses.

The first frame frequency may be two to five times higher than the second frame frequency.

The display panel may include a first left eye image frame, a second left eye image frame, a first right eye image frame, and a second right eye image frame, and the first left eye image frame and the first right eye image frame are scanned at the first frame frequency and the second left eye image frame and the second right eye image frame are scanned at the second frame frequency.

Two to five lines may be simultaneously scanned in the first left eye image frame and the first right eye image.

The shutter controller may control the left eye shutter to open in a left eye effective period in which the first left eye image frame and the second left eye image frame are mixed with each other, and may control the right eye shutter to open in a right eye effective period in which the first right eye image frame and the second right eye image frame are mixed with each other.

A portion of the left eye effective period comprising the second left eye image frame may be larger than a portion of the left eye effective period comprising the first left eye image frame.

The backlight unit may be turned on in the left eye effective period and in the right eye effective period, and be turned off in other periods.

The first left eye image frame and the first right eye image frame may be black.

The left eye shutter may be open in a left eye effective period in which the second left eye image frame and the first right eye image frame are mixed with each other, and the right eye shutter may be open in a right eye effective period in which the second right eye image frame and the first left eye image frame are mixed with each other.

The backlight unit may be turned on in the left eye effective period and in the right eye effective period, and be turned off in other periods.

According to another aspect of an exemplary embodiment, a stereoscopic display apparatus includes a display panel which sequentially scans a first left eye image, a second left eye image, a first right eye image, and a second right eye image, an image signal input unit which inputs an image signal to the display panel, a backlight unit which emits light to the display panel, and a shutter controller which controls a closing a left eye shutter and a right eye shutter in periods in which a left eye image and a right eye image are mixed with each other.

When the first left eye image, the second left eye image, the first right eye image, and the second right eye image are scanned, two to five lines may be simultaneously scanned.

The left eye shutter may be open in a period in which the second left eye image is scanned and the right eye shutter may be open in a period in which the second right eye image is scanned.

The second left eye image and the second right eye image may be black.

The left eye shutter may be open in a period in which the first left eye image is scanned and the right eye shutter may be open in a period in which the first right eye image is scanned.

According to another aspect of an exemplary embodiment, a stereoscopic display apparatus includes a display panel including a first region and a second region that are independently scanned, wherein each of the first region and the second region scans a first left eye image scanning period, a first left eye image holding period, a second left eye image scanning period, a second left eye image holding period, a first right eye image scanning period, a first right eye image holding period, a second right eye image scanning period, and a second right eye image holding period, an image signal input unit which inputs an image signal to the display panel, a backlight unit which emits light to the display panel, and a shutter controller which controls an opening of a left eye shutter in the first left eye image holding period, the second left eye image scanning period, and the second left eye image holding period, and an opening of a right eye shutter in the first right eye image holding period, the second right eye image scanning period, and the second right eye image holding period.

The backlight unit may be turned on in the first left eye image holding period, the second left eye image scanning period, and the second left eye image holding period, and may be turned on in the first right eye image holding period, the second right eye image scanning period, and the second right eye image holding period.

A frame frequency of the first left eye image scanning section and the first left eye image holding section may be an even-numbered multiple of 60 Hz.

Scanning of each of the first region and the second region may begin from an intermediate line of the display panel.

The first region may be scanned from a first line to a first intermediate line of the display panel and the second region may be scanned from a second intermediate line to a final line of the display panel.

The first region may be scanned from a first line to a first intermediate line of the display panel and the second region may be scanned from a final line to a second intermediate line of the display panel.

The first region and the second region may be simultaneously scanned.

According to another aspect of an exemplary embodiment, a stereoscopic display apparatus includes an image signal input which periodically generates a left eye image signal and a right eye image signal, a display panel which scans a right eye image holding period and a left eye image scanning period of a previous cycle during inputting of the left eye image signal, and a left eye image holding period and a right eye image scanning period during inputting of the right eye image signal, a backlight unit for emitting light to the display panel, and a shutter controller which controls an opening and closing a left eye shutter and a right eye shutter of shutter glasses.

According to another aspect of an exemplary embodiment, a method of driving a stereoscopic display apparatus includes inputting an image signal to a display panel, using an image signal input unit, scanning an image alternately at a first frame frequency and a second frame frequency, which is different from the first frame frequency, using the display panel, emitting light to the display panel, using a backlight unit, and selectively opening and closing a left eye shutter and a right eye shutter of shutter glasses, using a shutter controller.

According to another aspect of an exemplary embodiment, a method of driving a stereoscopic display apparatus includes inputting an image signal to a display panel, using an image signal input unit, sequentially scanning a first left eye image, a second left eye image, a first right eye image, and a second right eye image, using the display panel, emitting light to the display panel, using a backlight unit, and closing a left eye shutter and a right eye shutter in periods in which a left eye image and a right eye image are mixed with each other, using a shutter controller.

According to another aspect of an exemplary embodiment, a method of driving a stereoscopic display apparatus includes inputting an image signal to a display panel, using an image signal input unit, wherein the display panel includes a first region and a second region that are independently scanned, scanning a first left eye image period, holding the first left eye image in a first left eye image holding period, scanning a second left eye period, and holding the second left eye image in a second left eye image holding period, using the display panel, in each of the first region and the second region, scanning a first right eye image period, holding the first right eye image in a first right eye image period, scanning a second right eye period, holding the second right eye image in a second right eye image holding period, using the display panel, in each of the first region and the second region, emitting light to the display panel, using a backlight unit, and opening a left eye shutter in the first left eye image holding period, the second left eye image scanning period, and the second left eye image holding period, using a shutter controller, and opening a right eye shutter in the first right eye image holding period, the second right eye image scanning period, and the second right eye image holding period, using the shutter controller.

According to another aspect of an exemplary embodiment, a method for driving a stereoscopic display apparatus includes inputting a left eye image signal to a display panel, using an image signal input unit, scanning a left eye image while holding a right eye image previously scanned by the display panel during inputting of the left eye image signal, inputting a right eye image signal to the display panel, using the image signal input unit, scanning a right eye image while holding the left eye image, using the display panel, during inputting of the right eye image signal, emitting light to the display panel, using a backlight unit, and selectively opening and closing a left eye shutter and a right eye shutter of shutter glasses, using a shutter controller.

### BRIEF DESCRIPTION OF THE DRAWINGS

The above and/or other aspects and advantages will become more apparent by describing in detail exemplary embodiments with reference to the attached drawings in which:

FIG. 1 is a block diagram schematically illustrating a stereoscopic display apparatus according to an exemplary embodiment;

FIG. 2 illustrates a method of driving a stereoscopic display apparatus according to an exemplary embodiment;

FIG. 3 illustrates a method of driving a stereoscopic display apparatus according to another exemplary embodiment;

FIGS. 4 and 5 are timing diagrams used for driving a stereoscopic display apparatus according to an exemplary embodiment;

FIG. 6 illustrates an example of displaying a 2-D image in a method of driving a stereoscopic display apparatus according to another exemplary embodiment;

FIGS. 7 and 8 illustrate examples of displaying a 3-D image in methods of driving a stereoscopic display apparatus according to other exemplary embodiments;

FIG. 9 illustrates a stereoscopic display apparatus according to another exemplary embodiment;

FIGS. 10-13 illustrate methods of driving a stereoscopic display apparatus according to other exemplary embodiments;

FIGS. 14 and 15 illustrate methods of driving a stereoscopic display apparatus according to other exemplary embodiments;

FIG. 16 illustrates a stereoscopic display apparatus according to another exemplary embodiment;

FIG. 17 illustrates an example of a backlight unit used for the stereoscopic display apparatus of FIG. 16; and

FIG. 18 illustrates a stereoscopic display apparatus according to another exemplary embodiment.

### DETAILED DESCRIPTION

The attached drawings are referred to in order to gain a sufficient understanding of exemplary embodiments, the merits thereof, and the objectives accomplished by the implementation of exemplary embodiments. Hereinafter, exemplary embodiments will be described in detail with reference to the attached drawings. Like reference numerals in the drawings denote like elements.

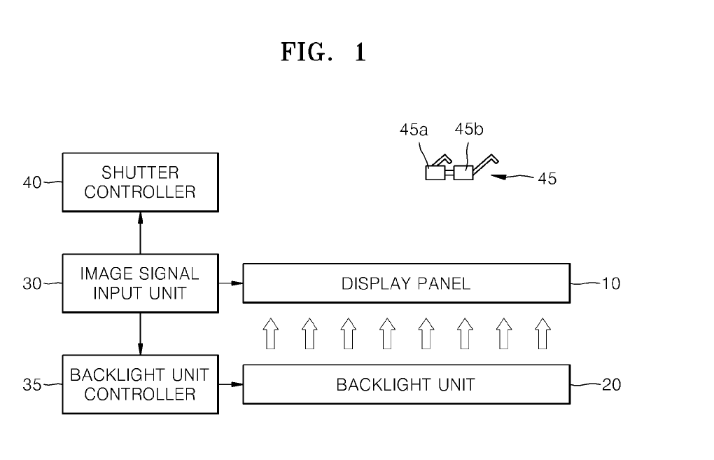

FIG. 1 is a block diagram schematically illustrating a stereoscopic display apparatus according to an exemplary embodiment of the present invention. Referring to FIG. 1, the stereoscopic display apparatus may include a display panel 10 for displaying an image, a backlight unit 20 for emitting light to the display panel 10, and an image signal input unit 30 for inputting an image signal to the display panel 10.

A stereoscopic display apparatus may comprise a liquid crystal display (LCD), a plasma display panel (PDP), or an organic light emitting diode (OLED) display panel. The display panel 10 includes a plurality of pixels, each pixel including a thin film transistor and an electrode. An image may be displayed according to a method of modulating light emitted from the backlight unit 20 by applying an electric field to liquid crystal in units of pixels according to an image signal input by the image signal input unit 30.

The backlight unit 20 may include a light source such as a cold cathode fluorescent light (CCFL) or a light emitting diode (LED). A backlight unit controller 35 may control the backlight unit 20. The backlight unit 20 may be a direct type backlight or an edge type backlight. The image signal input unit 30 may input a two dimensional (2-D) image signal or a 3-D image signal to the display panel 10.

In the stereoscopic display apparatus according to the present embodiment, a 3-D image may be viewed using shutter glasses 45. The image signal input unit 30 alternately inputs a left eye image signal and a right eye image signal to the display panel 10. A shutter controller 40 opens a left eye shutter 45a of the shutter glasses 45 and closes a right eye shutter 45b of the shutter glasses 45 in synchronization with the left eye image signal. Also, the shutter controller 40 closes the left eye shutter 45a of the shutter glasses 45 and opens the right eye shutter 45b of the shutter glasses 45 in synchronization with the right eye image signal. Thus, a 3-D image may be displayed.

However, the shutter controller 40 is not limited to being controlled only in synchronization with the right eye image signal and the left eye image signal. The shutter controller 40 may control the left eye shutter 45a and the right eye shutter 45b by selecting one or more sections of the right eye image signal and the left eye image signal. When the image signal input unit 30 inputs a 2-D image signal to the display panel 10, a 2-D image may be viewed without the shutter glasses 45.

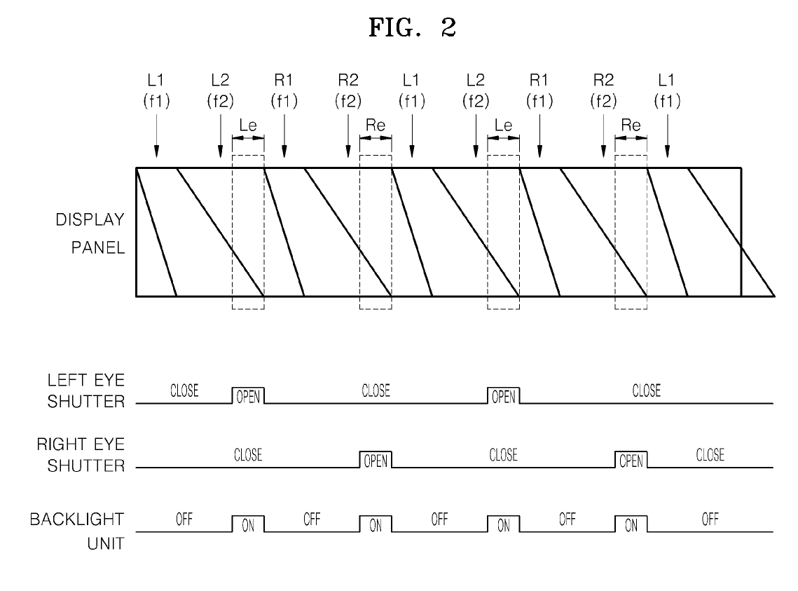

FIG. 2 illustrates a method of driving a stereoscopic display apparatus according to an exemplary embodiment. Referring to FIG. 2, the display panel 10 may scan an image alternatively at a first frame frequency f1 and a second frame frequency f2, which are different from each other. The first frame frequency f1 may be higher than the second frame frequency f2. For example, the first frame frequency f1 may be two to five times higher than the second frame frequency f2. For example, the first frame frequency f1 may be 360 Hz and the second frame frequency f2 may be 180 Hz, the first frame frequency f1 may be 480 Hz and the second frame frequency f2 may be 160 Hz, or the first frame frequency f1 may be 600 Hz and the second frame frequency f2 may be 150 Hz.

The display panel 10 may display a first left eye image frame, a second left eye image frame, a first right eye image frame, and a second right eye image frame. The display panel 10 may scan a first left eye image L1 at the first frame frequency f1 and a second left eye image L2 at the second frame frequency f2. Also, the display panel 10 may scan a first right eye image R1 at the first frame frequency f1 and a second right eye image R2 at the second frame frequency f2. To scan the first left eye image frame and the first right eye image frame at high speed, for example, two to five scanning lines (hereinafter, referred to as the lines) may be simultaneously scanned. To this end, a variety of methods may be used. For example, when two lines are simultaneously scanned, a data signal value input to the two lines may be, for example, an average of data signal values corresponding to the two lines or a data signal value of one of the two lines.

The shutter controller 40 may open the left eye shutter 45a and the right eye shutter 45b during a period in which a left eye image and a right eye image are not mixed. A period in which a left eye image is displayed by a combination of the opening of the left eye shutter 45a and the turning on of the backlight unit 20 is referred to as a left eye effective period Le. A section where a right eye image is displayed by a combination of the opening of the right eye shutter 45b and the turning on of the backlight unit 20 is referred to as a right eye effective period Re. For example, the left eye effective period Le may include part of the first left eye image period L1 and part of the second left eye image period L2. The left eye shutter 45a may be open in the left eye effective period Le. For example, the right eye effective period Re may include part of the first right eye image period R1 and part of the second right eye image period R2. The right eye shutter 45b may be open in the right eye effective period Re. In the following description, the same reference letters L and R will be used for both an image and an image period, or time during which the image signal is scanned.

In the method of driving a stereoscopic display apparatus according to the present embodiment, a period during which the first frame frequency f1 is used may be used as a data activation period and a period during which the second frame frequency f2 is used may be used as a data optical maintenance period. For example, it is difficult to increase a frame frequency because there is a limit to the response speed of the display panel 10. Accordingly, when the display panel 10 scans a period using the first frame frequency f1 during which the display panel is activated according to image data and then the activated display panel scans a period at the second frame frequency f2, the slow response speed of the display panel 10 may be compensated for and an optical maintenance period for optically displaying an image may be obtained. That is, by scanning the first left eye image frame at the first frame frequency f1 that is a high speed frequency in order to activate data, the optical maintenance period may be obtained, and the second left eye frame may be scanned at the second frame frequency that is desired. For example, when the first left eye image L1 is scanned at a frequency of 360 Hz to activate data and then the second left eye image L2 is scanned at a frequency of 180 Hz, even when the second frame frequency f2 of the second left eye image L2 is rather higher than the first frame frequency f1 of the second left eye image L2, the display panel 10 may respond more quickly because the data has already been activated in advance by the scanning of the first left eye image L1. In this way, a left eye image may be displayed by selecting a part of the second left eye image period L2 as the left eye effective period Le, and opening the left eye shutter 45a and turning the backlight unit 20 on during the left eye effective period Le. The left eye effective period Le may include a part of the first left eye image period L1. To make a display region of the second left eye image L2 larger than that of the first left eye image L1, a period in which the first left eye image L1 and the second left eye image L2 are mixed is selected and thus a left eye image may be displayed.

Data may be activated by scanning the first right eye image frame R1 at the first frequency f1. An optical maintenance period may be obtained by scanning the second right eye image frame R2 at the second frame frequency f2. A right eye image may be displayed by selecting part of the second right eye image period R2 as the right eye effective period Re, and opening the right eye shutter 45b and turning the backlight unit 20 on in the right eye effective period Re. The right eye effective period Re may include part of the first right eye image period R1. To make a display region of the second right eye image R2 larger than that of the first right eye image R1, a period in which the first right eye image R1 and the second right eye image R2 are mixed is selected and thus a right eye image may be displayed. Accordingly, a left eye image and a right eye image may be displayed without crosstalk. Since data activation periods are provided, the optical maintenance periods may be obtained so that high luminance may be achieved.

An image may be viewed in selected periods by using a combination of opening and closing the left eye shutter 45a and the right eye shutter 45b and turning on and off the backlight unit 20. For example, the left eye shutter 45a may be open in the left eye effective period Le and the right eye shutter 45b may be open in the right eye effective period Re. The backlight unit 20 may be turned on in the left eye effective period Le and in the right eye effective period Re. Alternatively, the backlight unit 20 may be continuously turned on.

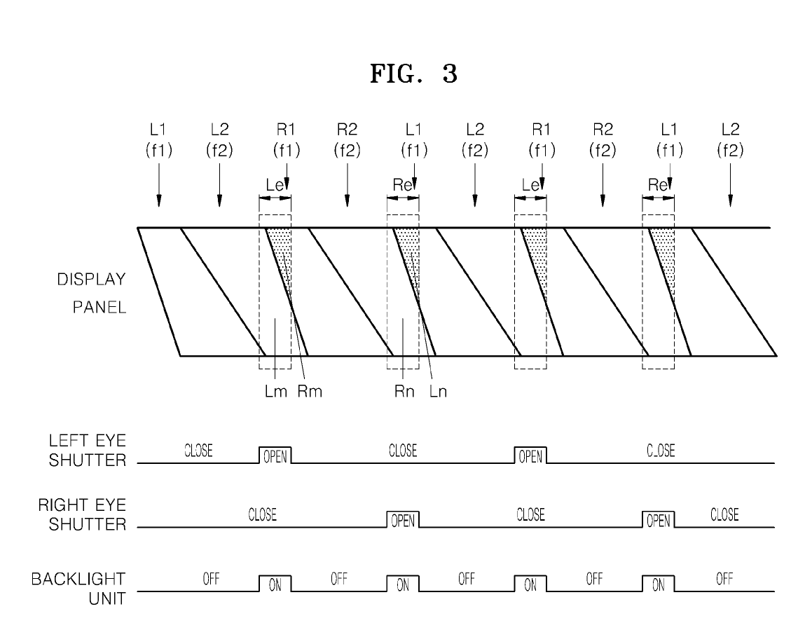

Referring to FIG. 3, the display panel 10 may scan the first left eye image frame, the second left eye image frame, the first right eye image frame, and the second right eye image frame. The display panel 10 may scan the first left eye image L1 at the first frame frequency f1 and the second left eye image L2 at the second frame frequency f2. Also, the display panel 10 may scan the first right eye image R1 at the first frame frequency f1 and the second right eye image R2 at the second frame frequency f2. The first left eye image L1 may be black. The second left eye image L2 may be the left eye image. The first right eye image R1 may be black. The second right eye image R2 may be the right eye image. The left eye effective period Le in which the left eye image is displayed may include part of the second left eye image period L2 and part of the first right eye image period R1, in which black is displayed. The left eye effective period Le may further include part of the first left eye image period L1, in which black is displayed. A second left eye image portion Lm included in the left eye effective period Le may be larger than a first right eye image portion Rm included in the left eye effective period Le. The first right eye image portion Rm included in the left eye effective period Le may not substantially display the first right eye image (black) due to a delay in a response time of the display panel 10. Thus, the second left eye image L2 may be displayed during the left eye effective period Le. Even when part of the first left eye image (black) is included in the left eye effective period Le, the first left eye image will not be recognized by a viewer. Therefore, the left eye image may be displayed without a mixture of the left eye image and the right eye image.

The right eye effective period Re for displaying the right eye image may include part of the second right eye image period R2 and part of the first left eye image period L1, in which black is displayed. The right eye effective period Re may further include part of the first right eye image period R1 in which black is displayed. A second right eye image portion Rn included in the right eye effective period Re may be larger than a first left eye image portion Ln included in the right eye effective period Re. The first left eye image portion Ln included in the right eye effective period Re may not substantially display the first left eye image (black) due to a delay in a response time of the display panel 10. Thus, the second right eye image R2 may be displayed during the right eye effective period Re. Even when part of the first right eye image (black) is included in the right eye effective period Re, the first right eye image will not be recognized by a viewer. Therefore, the right eye image may be displayed without a mixture of the left eye image and the right eye image.

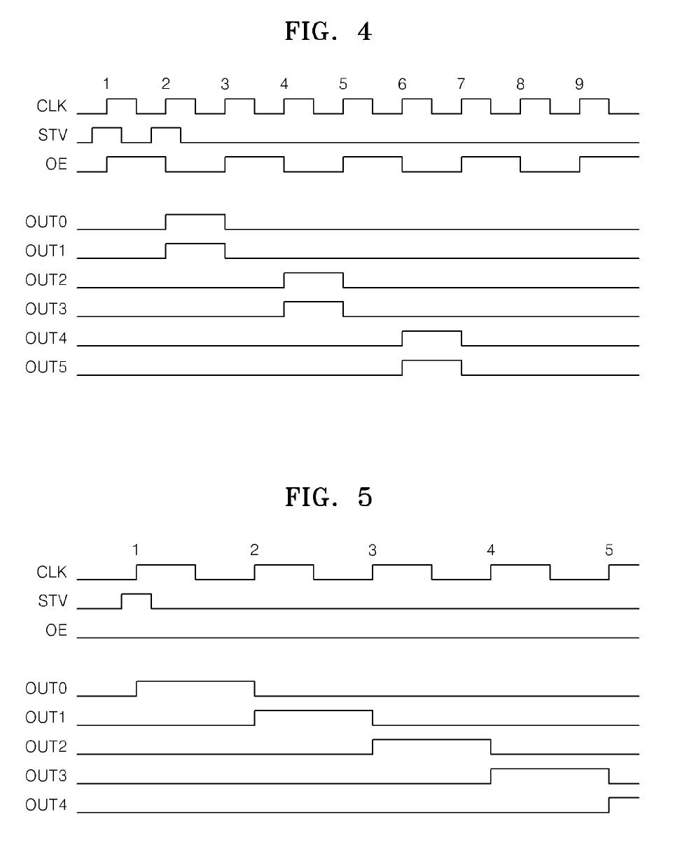

FIG. 4 is a timing diagram illustrating an example in which an image is scanned at the first frame frequency f1. In FIG. 4, two lines are simultaneously scanned. FIG. 5 is a timing diagram illustrating an example in which an image is scanned at the second frame frequency f2. In FIG. 5, a single line is scanned by one time.

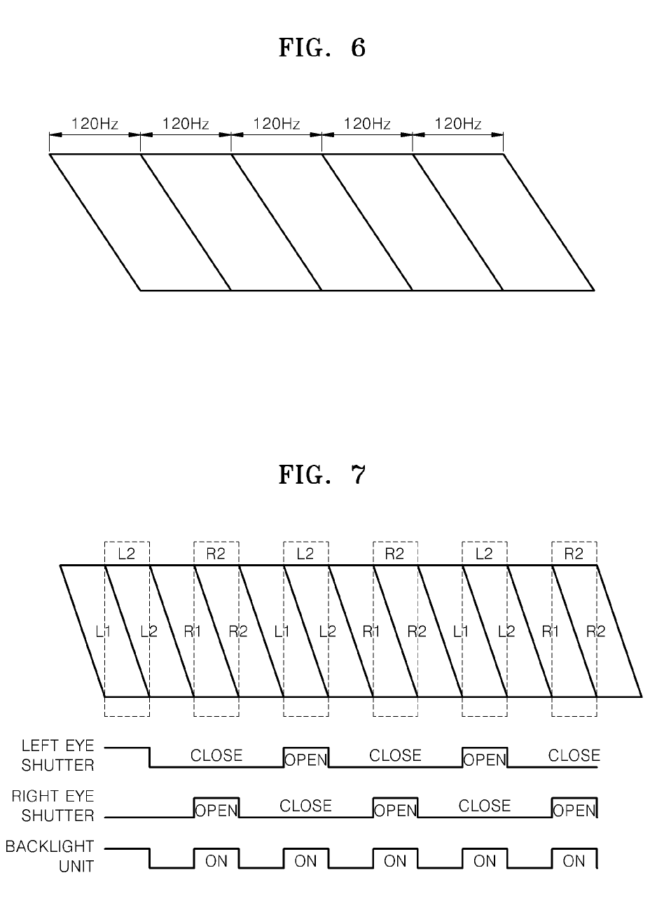

FIGS. 6, 7, and 8 illustrate other exemplary embodiments. FIG. 6 illustrates an example of a 2-D image. Referring to FIG. 6, an image may be displayed regardless of the left eye image and the right eye image by scanning the image at the first frame frequency f1, for example, a frame frequency of 120 Hz. In this case, a single line is scanned at one time, and a 2-D image may be viewed with the naked eye without shutter glasses. The first frame frequency is not limited to 120 Hz, and a frame frequency of, for example, 60 Hz, may be used for scanning.

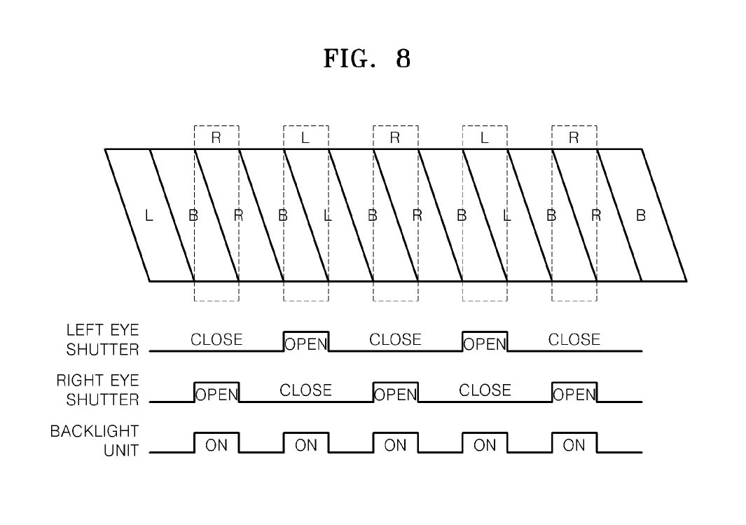

FIG. 7 illustrates an example of displaying a 3-D image by scanning the first left eye image L1, the second left eye image L2, the first right eye image R1, and the second right eye image R2 at the second frame frequency f2. The second frame frequency f2 may be higher than the first frame frequency f1. For example, the second frame frequency f2 may be two to five times higher than the first frame frequency f1. For example, by simultaneously scanning two to five lines at one time, the first left eye image L1, the second left eye image L2, the first right eye image R1, and the second right eye image R2 may be scanned at a high speed. When two lines are simultaneously scanned, the first left eye image L1, the second left eye image L2, the first right eye image R1, and the second right eye image R2 may be scanned at the second frame frequency of, for example, 240 Hz. In this case, a data signal value input to the two lines may be, for example, an average of data signal values corresponding to the two lines or a data signal value of one of the two lines. For example, when a data signal value of one of two lines is used, the first left eye image L1 may input a data signal value of an even-numbered line, whereas the second left eye image L2 may input a data signal value of an odd-numbered line. Also, the first right eye image R1 may input a data signal value of an even-numbered line, whereas the second right eye image R2 may input a data signal value of an odd-numbered line.

The shutter controller 40 may open the left eye shutter 45a in the second left eye image period L2 and the right eye shutter 45b in the second right eye image period R2. The backlight unit 20 may be turned on in the second left eye image section L2 and in the second right eye image section R2 or may be turned on in all periods.

FIG. 8 illustrates an example of displaying a 3-D image by scanning the left eye image L, a black image B, the right eye image R, and a black image B at the second frame frequency f2. When the left eye image L and the right eye image R are displayed, for example, two to five lines may be simultaneously scanned. The shutter controller 40 may open the left eye shutter 45a in the left eye image period L and the right eye shutter 45b in the right eye image period R. The backlight unit 20 may be turned on in the left eye image period L and in the right eye image period R or may be turned on in all periods. The left eye effective period Le and the right eye effective period Re may be selected by a combination of opening and closing the left eye shutter 45a and the right eye shutter 45b and turning on and off the backlight unit 20.

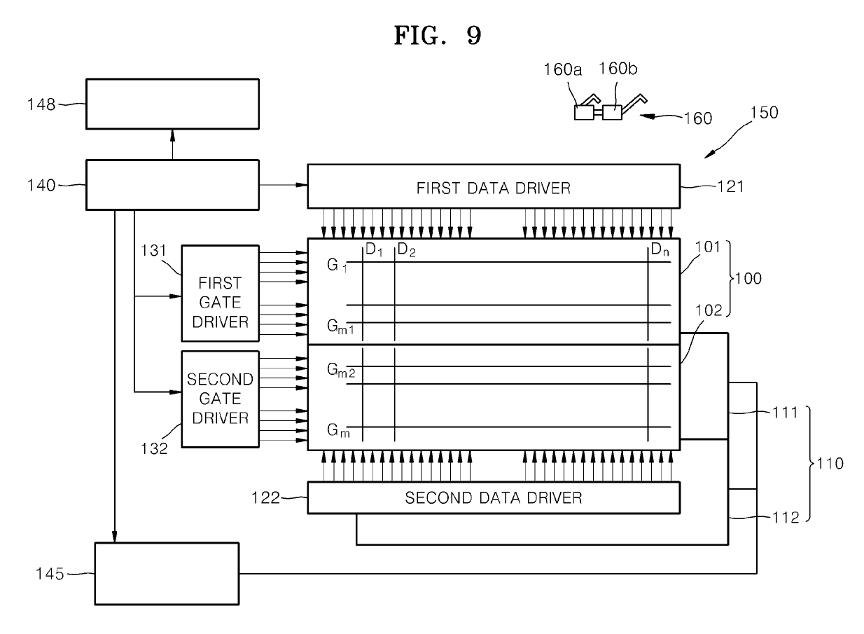

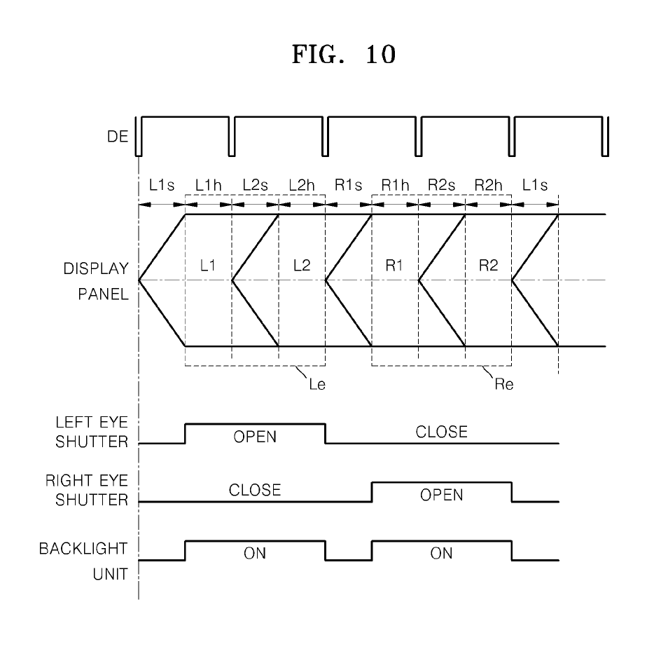

FIG. 9 illustrates a stereoscopic display apparatus 150 according to another exemplary embodiment. Referring to FIG. 9, the stereoscopic display apparatus 150 may include a display panel 100 including a first region 101 and a second region 102 that are independently operable and a backlight unit 110 for separately supplying light to the first region 101 and the second region 102. The first region 101 and the second region 102 may respectively correspond to an upper region and a lower region of the display panel 100.

The backlight unit 110 may include a first backlight region 111 corresponding to the first region 101 and a second backlight region 112 corresponding to the second region 102. The stereoscopic display apparatus 150 may include a first data driver 121 for supplying a data signal to the first region 101 of the display panel 100 and a second data driver 122 for supplying a data signal to the second region 102 of the display panel 100. Also, the stereoscopic display apparatus 150 may include a first gate driver 131 for supplying a scan signal to the first region 101 in response to the data signal and a second gate driver 132 for supplying a scan signal to the second region 102 in response to the data signal.

The display panel 100 may include (m×n) number of pixels arranged in a matrix format. N-number of data lines D1-Dn and m-number of scanning lines G1-Gm cross each other. A thin film transistor (TFT) may be formed at each of the cross points where one the data lines D1-Dn meet one of the scanning lines G1-Gm (hereinafter, referred to as the lines). The first region 101 may include lines from a first line G1 to a first intermediate line Gm1, whereas the second region 102 may include lines from a second intermediate line Gm2 to a final line Gm. The first intermediate line Gm1 may be the final line of the first region 101, whereas the second intermediate line Gm2 may be the first line of the second region 102.

A backlight unit controller 145 may control the backlight unit 110 according to a vertical sync signal input by an image signal input unit 140. The image signal input unit 140 may include a timing controller (not shown). The first and second data drivers 121 and 122 and the first and second gate drivers 131 and 132 may be controlled by the image signal input unit 140. The image signal input unit 140 may control the first and second data drivers 121 and 122 by using a horizontal sync signal and the first and second gate drivers 131 and 132 by using a vertical sync signal. The first and second regions 101 and 102 may be simultaneously driven. A shutter controller 148 may control the opening and closing of a left eye shutter 160a and a right eye shutter 160b in shutter glasses 160 according to a signal output from the image signal input unit 140.

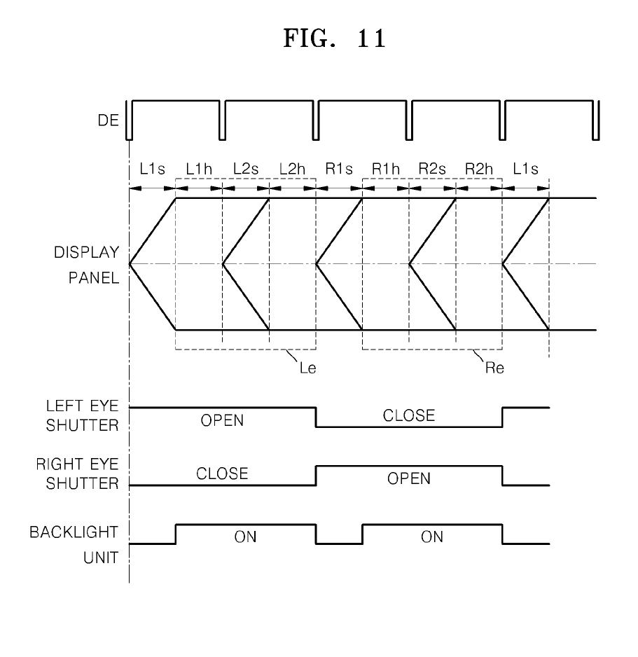

FIG. 10 is a schematic timing diagram of the display panel 100. Each of the first and second regions 101 and 102 of the display panel 100 may include a first left eye image scanning period L1s, a first left eye image holding period L1h, a second left eye image scanning period L2s, a second left eye image holding period L2h, a first right eye image scanning period R1s, a first right eye image holding period R1h, a second right eye image scanning period R2s, and a second right eye image holding period R2h. An image may be held by preventing a gate signal or a data signal from being input to the display panel 100 so as to keep a state of the display panel 100 without change.

The left eye effective period Le in which a left eye image is displayed may include the first left eye image holding period L1h, the second left eye image scanning period L2s, and the second left eye image holding period L2h. Also, the right eye effective period Re in which a right eye image is displayed may include the first right eye image holding period R1h, the second right eye image scanning period R2s, and the second right eye image holding period R2h. The left eye effective period Le and the right eye effective period Re may be selected by a combination of opening and closing operations of a left eye shutter 160a and a right eye shutter 160b in shutter glasses 160 and turning on and off operations of the backlight unit 110.

The shutter controller 150 may open the left eye shutter 45a in the first left eye image holding period L1h, the second left eye image scanning period L1s, and the second left eye image holding period L2h, and may open the right eye shutter 45b in the first right eye image holding period R1h, the second right eye image scanning period R1s, and the second right eye image holding period R2h. The backlight unit 110 may perform a blinking operation by being turned on in the first left eye image holding period L1h, the second left eye image scanning period L1s, and the second left eye image holding period L2h and in the first right eye image holding period R1h, the second right eye image scanning period R1s, and the second right eye image holding period R2h, and by being turned off in the other periods. Alternately, the backlight unit 110 may be turned on in all periods.

When the left eye image is input, the first region 101 and the second region 102 of the display panel 100 may be simultaneously scanned. As illustrated in FIG. 10, scanning may be performed from the first intermediate line Gm1 to the first line G1 of the display panel 100 in the first region 101, and from the second intermediate line Gm2 to the final m line Gm of the display panel 100 in the second region 102. When the scanning is performed by dividing the display panel 100 into two parts, as compared to a case of scanning the display panel 100 without dividing the same into two parts, an image may be output twice as fast and thus the display panel 100 may have a relatively longer image holding time. For example, when the first left eye image L1 has a 240 Hz frame frequency and the second left eye image L2 has a 240 Hz frame frequency, the left eye image may be displayed without crosstalk between the left eye image and the right eye image for a period of ¾ of 1/120 seconds, that is, 160 Hz. A period in which a left eye image can be displayed without crosstalk may be increased. Similarly for the right eye image, a period in which a right eye image can be displayed without crosstalk may be increased. The frame frequency of the first left eye image scanning period and the first left eye image holding period may have a frequency of an even-numbered multiple of 60 Hz.

FIG. 11 illustrates another example of a combination of the opening and closing of a left eye shutter and a right eye shutter and the turning on and off of the backlight unit 110. Referring to FIG. 11, the left eye shutter 45a of FIG. 1 may be open in the first left eye image scanning period L1s, the first left eye image holding period L1h, the second left eye image scanning period L2s, and the second left eye image holding period L2h, and the right eye shutter 45b of FIG. 1 may be open in the first right eye image scanning period R1s, the first right eye image holding period R1h, the second right eye image scanning period R2s, and the second right eye image holding period R2h. The backlight unit 110 may be turned on in the first left eye image holding period L1h, the second left eye image scanning period L2s, and the second left eye image holding period L2h, and also in the first right eye image holding period R1h, the second right eye image scanning period R2s, and the second right eye image holding period R2h, and turned off in the other periods.

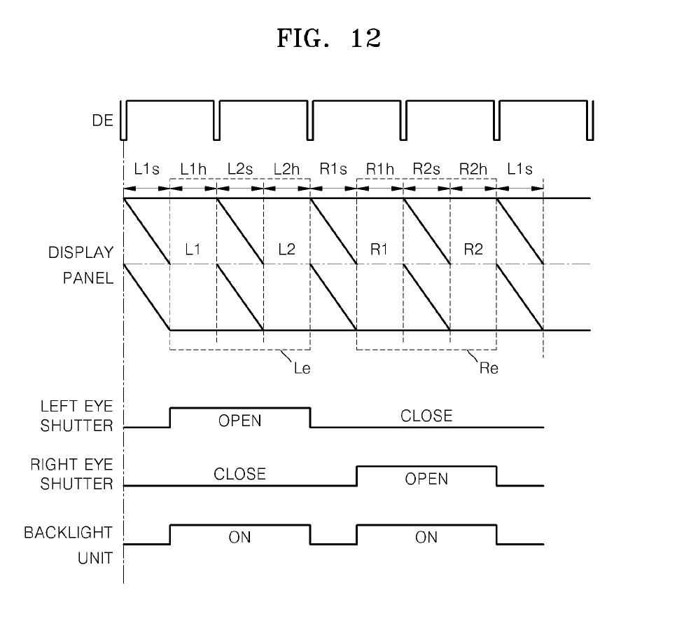

FIG. 12 illustrates an example in which the scanning direction is changed in the first region 101 and the second region 102 of the display panel 100. Referring to FIGS. 9 and 12, in the first region 101, scanning may be performed from the first line G1 to the first intermediate line Gm1 of the display panel 100. In the second region 102, scanning may be performed from the second intermediate line Gm2 to the final line Gm of the display panel 100. The left eye shutter 160a may be open in the left eye effective period Le in which the left eye image and the right eye image are not mixed with other. The right eye shutter 160b may be open in the right eye effective period Re in which the left eye image and the right eye image are not mixed with other. The backlight unit 110 may be turned on in the left eye effective period Le and in the right eye effective period Re.

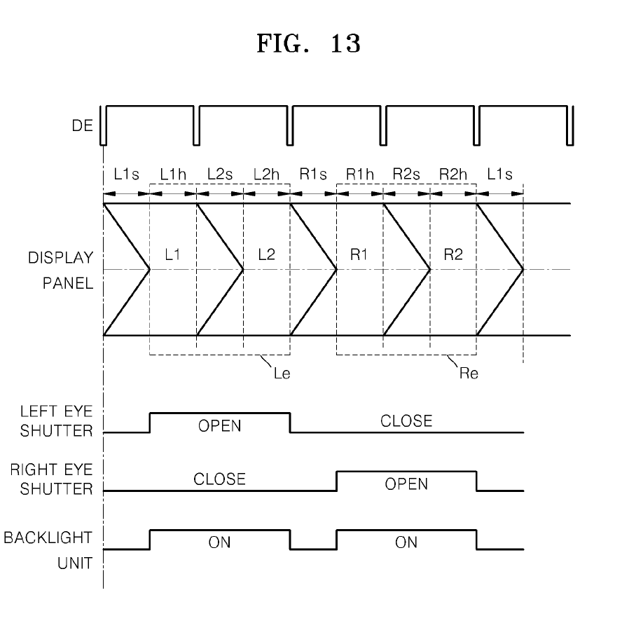

FIG. 13 illustrates another example in which the scanning direction is changed in the first region 101 and the second region 102 of the display panel 100. Referring to FIGS. 9 and 13, in the first region 101, scanning may be performed from the first line G1 to the first intermediate line Gm1 of the display panel 100. In the second region 102, scanning may be performed from the final line Gm to the second intermediate line Gm2 of the display panel 100. The left eye effective period Le and the right eye effective period Re may be selected regardless of the scanning direction in the scanning period. The left eye image and the right eye image may be displayed in the left eye effective period Le and the right eye effective period Re, without crosstalk, by a combination of the opening and closing operations of the left eye shutter 160a and the right eye shutter 160b and the turning on and off operations of the backlight unit 110.

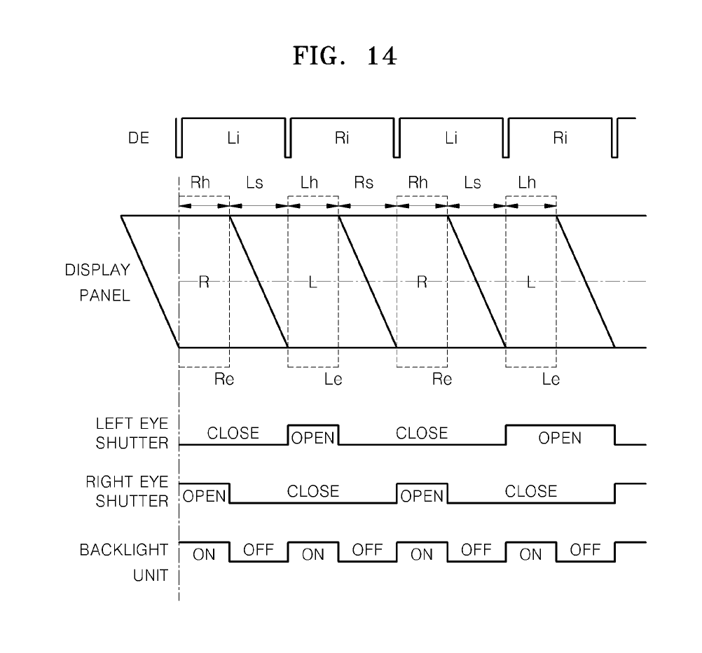

FIG. 14 is a timing diagram for explaining a method of driving a stereoscopic display apparatus according to another exemplary embodiment of the present invention. Referring to FIGS. 1 and 14, the right eye shutter 45b is open to display the right eye image during a frame in which a left eye image signal Li is input, whereas the left eye shutter 45a is open to display the left eye image during a frame in which a right eye image signal Ri is input. The display panel 10 may periodically scan the right eye image scanning period Rs, the right eye image holding period Rh, the left eye image scanning period Ls, and the left eye image holding period Lh. The image signal input unit 30 may input the left eye image signal Li to the display panel 10 in the right eye image holding period Rh and the left eye image scanning period Ls, and the right eye image signal Ri to the display panel 10 in the left eye image holding period Lh and the right eye image scanning period Rs of the next cycle. When the image signal input unit 30 inputs the left eye image signal Li, the display panel 10 holds a right eye image R of the previous cycle for a predetermined period and then scans the left eye image L according to the left eye image signal Li. When the image signal input unit 30 inputs the right eye image signal Ri, the display panel 10 holds the left eye image L for a predetermined period and then scans the right eye image R according to the right eye image signal Ri. An image may be held by preventing a gate signal (or a scanning signal) or a data enable signal DE of the display panel 10 from being output so as to maintain a state of liquid crystal unchanged. The previous state of the display panel may be held by preventing a gate signal being output although the data signal is output.

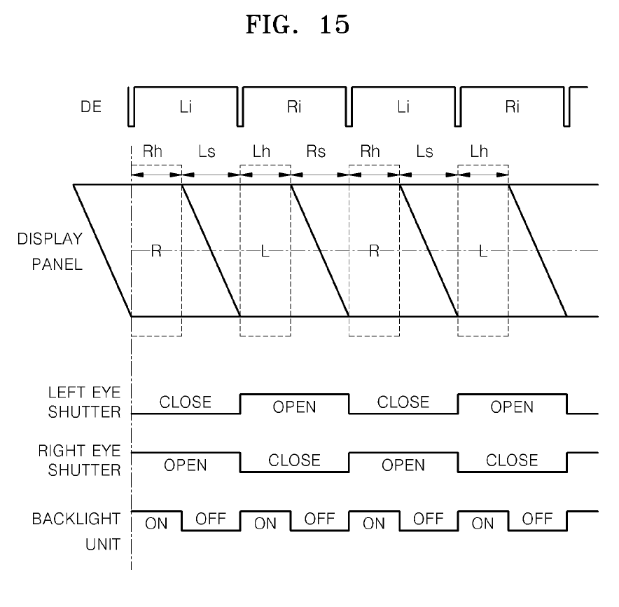

The right eye shutter 45b may be open in the right eye image holding period Rh. The left eye shutter 45a may be open in the left eye image holding period Lh. The backlight unit 20 may be turned on in the right eye image holding period Rh and the left eye image holding period Lh, and be turned off in the other periods. Alternatively, as illustrated in FIG. 15, the right eye shutter 45b may be open in the right eye image holding period Rh and the left eye image scanning period Ls, the left eye shutter 45a may be open in the left eye image holding period Lh and the right eye image scanning period Rs, and the backlight unit 20 may be turned on in the right eye image holding period Rh and the left eye image holding period Lh.

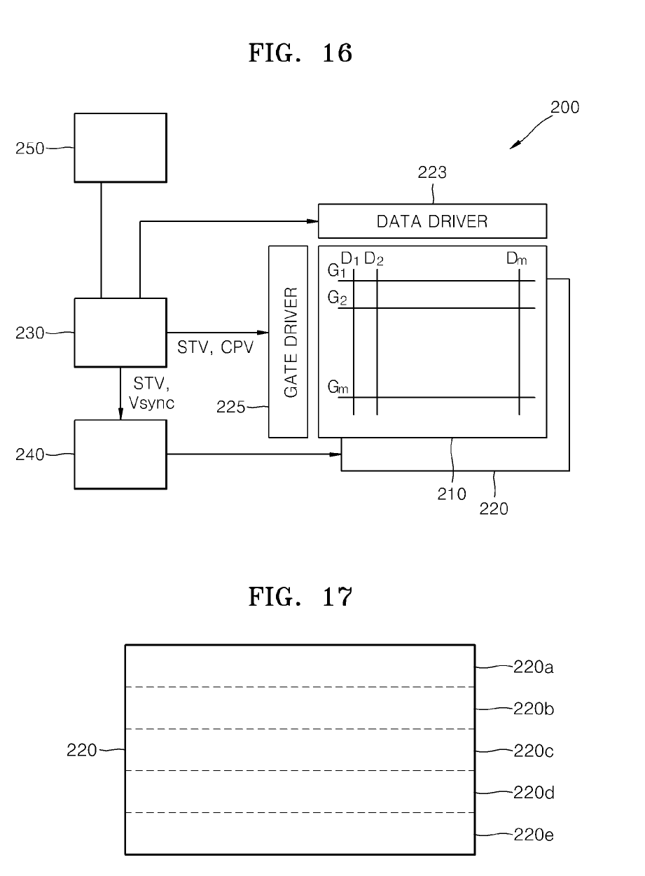

FIG. 16 illustrates a stereoscopic display apparatus 200 according to another exemplary embodiment. Referring to FIG. 16, the stereoscopic display apparatus 200 may include a display panel 210, a backlight unit 220, and an image signal input unit 230. The image signal input unit 230 may include a timing controller (not shown). The stereoscopic display apparatus 200 may further include a data driver 223 for supplying a data signal to the display panel 210 and a gate driver 225 for supplying a scanning signal to the display panel 210. Image data and timing control data may be extracted from a left eye image signal and a right eye image signal output from the image signal input unit 230. The image data may be transmitted through a mini-LVDS signal and may include a polarity control (POL) signal or a latch clock input (TP) signal. A gate timing control signal may include a start vertical (STV) signal and a clock pulse vertical (CPV) signal.

The display panel 210 may include (m×n) number of pixels arranged in a matrix format. N-number of data lines D1-Dn and m-number of gate lines (or scanning lines) G1-Gm are arranged to cross each other. A thin film transistor (TFT) may be formed at positions at which one of the data lines D1-Dn meet one of the gate lines G1-Gm. The gate driver 225 may sequentially supply scanning selection signals to the gate lines G1-Gm in response to the timing control data generated by the image signal input unit 230, so as to select a line to which a data voltage is supplied. The data driver 223 may supply the image data supplied by the image signal input unit 230 to a corresponding data line.

A backlight unit controller 240 may control the backlight unit 220 according to a signal input by the image signal input unit 230. The backlight unit controller 240 may control a blinking operation or a scanning operation of the backlight unit 220. The backlight unit controller 240 may generate a backlight driving control signal by using a vertical sync signal Vsync of the image signal extracted from the image signal input unit 230. Also, a shutter controller 250 may generate a shutter glasses control signal using the vertical sync signal Vsync of the image signal extracted from the image signal input unit 230. In another embodiment, the STV signal may be used as a reference signal for a backlight unit control signal. The backlight unit control unit 240 may generate a toggle type backlight driving control signal in synchronization with the vertical sync signal by using a logic circuit such as a latch or an inverter. The backlight unit control unit 240 may turn the backlight 220 off during periods in which a left eye image and a right eye image are mixed with each other, and turn the backlight unit 220 on during periods in which only a left eye image or a right eye image is displayed.

In another embodiment, the backlight unit control unit 240 may generate a backlight driving control signal for adjusting a turn-on cycle and turn-on section of the backlight unit 220 that is divided into a plurality of blocks, in response to a vertical sync signal V-sync of an image signal generated by the image signal input unit 230. Referring to FIG. 17, the backlight unit 220 may be sectioned into first to fifth blocks 220a, 220b, 220c, 220d, and 220e, and the turn-on section of the backlight unit 220 may be adjusted for each block. For example, the backlight unit 220 may be turned on and off in units of blocks according to scanning of an image.

The backlight unit 220 emits light to the display panel 210 according to a backlight driving signal output from the backlight unit controller 240. Since the display panel 210 displays an image in the left eye effective period Le and the right eye effective period Le in which the left eye image and the right eye image are not mixed with each other, crosstalk may be reduced or removed. There may be a variety of methods to selectively display an image in only those sections in which the left eye image and the right eye image are not mixed with each other. For example, the backlight unit 220 may be turned on only in periods in which the left eye image and the right eye image are not mixed with each other and turned off in the other periods. Thus, a stereoscopic image without crosstalk may be displayed by controlling the opening and closing of a left eye shutter and a right eye shutter corresponding to the image displayed in each period.

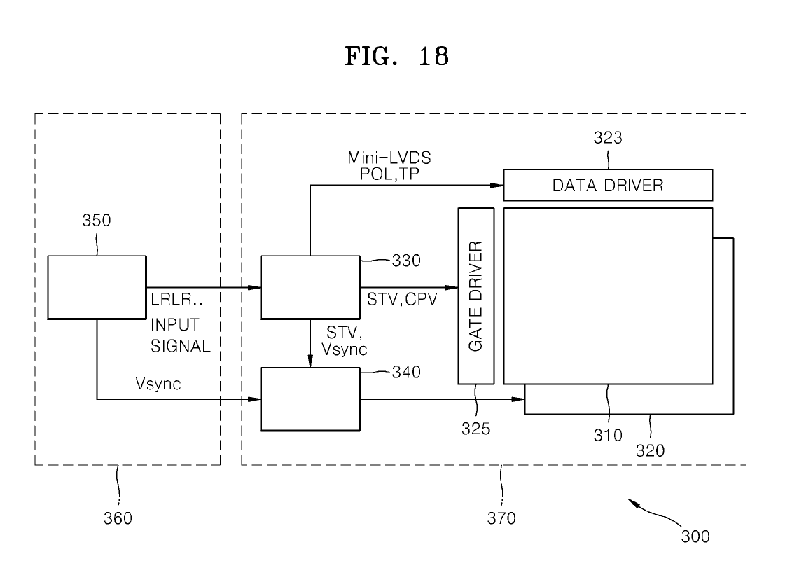

FIG. 18 illustrates a stereoscopic display apparatus 300 according to another exemplary embodiment. Referring to FIG. 18, the stereoscopic display apparatus 300 according to the present embodiment may include a display unit 360 for displaying an image and an image signal input unit 360 for inputting an image signal to a display unit 370. The display unit 350 may include a display panel 310 and a backlight unit 320. The image signal input unit 360 may include an image board 350. Since the image signal input unit 360 is provided as separate equipment from the display unit 370, an external image signal may be input to the display unit 370. A data driver 323 for supplying a data signal to the display panel 310 and a gate driver 325 for supplying a scan signal to the display panel 310 may be provided.

The image signal input unit 360 may modulate a vertical sync signal Vsync in the image board 350 and transmit a modulated vertical sync signal to a timing controller 330. The timing controller 330 inputs a signal to the gate driver 325 of the display panel 310. The vertical sync signal Vsync may be input to a backlight unit controller 340 from the image board 350. The backlight unit controller 340 may control the backlight unit 220 in synchronization with the vertical sync signal Vsync.

The backlight unit 320 emits light to the display panel 310 according to a backlight driving signal output from the backlight unit controller 340. A display panel 310 displaying an image in periods in which a left eye image and a right eye image are not mixed with each other may reduce or remove crosstalk. A method of displaying an image in periods in which a left eye image and a right eye image are not mixed with each other is described above with reference to FIGS. 2-15.

While exemplary embodiments have been particularly shown and described, it will be understood by those skilled in the art that various changes in form and details may be made therein without departing from the spirit and scope of the inventive concept as defined by the appended claims.

What is claimed is:

1. A stereoscopic display apparatus comprising:
a display panel which scans images alternately at a first frame frequency and a second frame frequency different from the first frame frequency;
an image signal input unit which inputs an image signal to the display panel;
a backlight unit which emits light to the display panel; and
a shutter controller which controls an opening and closing of a left eye shutter and a right eye shutter of shutter glasses.

2. The stereoscopic display apparatus of claim 1, wherein the first frame frequency is two to five times higher than the second frame frequency.

3. The stereoscopic display apparatus of claim 1, wherein the display panel comprises a first left eye image frame, a second left eye image frame, a first right eye image frame, and a second right eye image frame, and the first left eye image frame and the first right eye image frame are scanned at the first frame frequency and the second left eye image frame and the second right eye image frame are scanned at the second frame frequency.

4. The stereoscopic display apparatus of claim 3, wherein in the first left eye image frame and in the first right eye image frame, two to five lines are simultaneously scanned.

5. The stereoscopic display apparatus of claim 3, wherein the shutter controller controls the left eye shutter to open in a left eye effective period in which the first left eye image frame and the second left eye image frame are mixed with each other, and controls the right eye shutter to open in a right eye effective period in which the first right eye image frame and the second right eye image frame are mixed with each other.

6. The stereoscopic display apparatus of claim 5, wherein, in the left eye effective period in which the first left eye image frame and the second left eye image frame are mixed with each other, a portion of the left eye effective period comprising the second left eye image frame is larger than a portion of the left eye effective period comprising the first left eye image frame.

7. The stereoscopic display apparatus of claim 6, further comprising a backlight unit which emits light to the display panel, wherein the backlight unit is turned on in the left eye effective period and in the right eye effective period and is turned off in other periods.

8. The stereoscopic display apparatus of claim 3, wherein the first left eye image frame and the first right eye image frame are black.

9. The stereoscopic display apparatus of claim 8, wherein the shutter controller controls the left eye shutter to be open in a left eye effective period in which the second left eye image frame and the first right eye image frame are mixed with each other, and controls the right eye shutter to be open in a right eye effective period in which the second right eye image frame and the first left eye image frame are mixed with each other.

10. The stereoscopic display apparatus of claim 9, further comprising a backlight unit which emits light to the display panel, wherein the backlight unit is turned on in the left eye effective period and in the right eye effective period and is turned off in other periods.

11. A stereoscopic display apparatus comprising:
a display panel which sequentially scans a first left eye image, a second left eye image, a first right eye image, and a second right eye image;
an image signal input unit which inputs an image signal to the display panel;
a backlight unit which emits light to the display panel; and
a shutter controller which controls a closing of a left eye shutter and a right eye shutter in periods in which a left eye image and a right eye image are mixed with each other.

12. The stereoscopic display apparatus of claim 11, wherein, when the display panel scans the first left eye image, the second left eye image, the first right eye image, and the second right eye image, two to five lines are simultaneously scanned.

13. The stereoscopic display apparatus of claim 11, wherein the shutter controller controls the left eye shutter to be open in periods in which the second left eye image is scanned and controls the right eye shutter to be open in periods in which the second right eye image is scanned.

14. The stereoscopic display apparatus of claim 11, wherein the second left eye image and the second right eye image are black.

15. The stereoscopic display apparatus of claim 14, wherein the shutter controller controls the left eye shutter to be open in periods in which the first left eye image is scanned and controls the right eye shutter to be open in periods in which the first right eye image is scanned.

16. A stereoscopic display apparatus comprising:
a display panel comprising a first region and a second region that are independently scanned, wherein each of the first region and the second region scans a first left eye image scanning period, a first left eye image holding period, a second left eye image scanning period, a second left eye image holding period, a first right eye image scanning period, a first right eye image holding period, a second right eye image scanning period, and a second right eye image holding period;
an image signal input unit which inputs an image signal to the display panel;
a backlight unit for emitting light to the display panel; and
a shutter controller which controls an opening of a left eye shutter in the first left eye image holding period, the second left eye image scanning period, and the second left eye image holding period, and controls an opening of a right eye shutter in the first right eye image holding period, the second right eye image scanning period, and the second right eye image holding period.

17. The stereoscopic display apparatus of claim 16, further comprising a backlight unit which emits light to the display panel, wherein the backlight unit is turned on in the first left eye image holding period, the second left eye image scanning period, and the second left eye image holding period, and is turned on in the first right eye image holding period, the second right eye image scanning period, and the second right eye image holding period.

18. The stereoscopic display apparatus of claim 16, wherein a frame frequency of the first left eye image scanning period and the first left eye image holding period is an even-numbered multiple of 60 Hz.

19. The stereoscopic display apparatus of claim 16, wherein each of the first region and the second region begins scanning from an intermediate line of the display panel.

20. The stereoscopic display apparatus of claim 16, wherein the first region scans from a first line of the display panel to a first intermediate line of the display panel and the second region scans from a second intermediate line of the display panel to a final line of the display panel.

21. The stereoscopic display apparatus of claim 16, wherein the first region scans from a first line of the display panel to a first intermediate line of the display panel and the second region scans from a final line of the display panel to a second intermediate line of the display panel.

22. The stereoscopic display apparatus of claim 16, wherein the first region and the second region scan simultaneously.

23. A stereoscopic display apparatus comprising:
an image signal input unit which periodically inputs a left eye image signal and a right eye image signal;
a display panel which scans a right eye image holding period and a left eye image scanning period of a previous cycle during inputting of the left eye image signal, and scans a left eye image holding period and a right eye image scanning period during inputting of the right eye image signal; and
a shutter controller for which controls an opening and a closing of a left eye shutter and a right eye shutter of shutter glasses.

24. The stereoscopic display apparatus of claim 23, wherein the shutter controller opens the right eye shutter in the right eye image holding period, and opens the left eye shutter in the left eye image holding period.

25. The stereoscopic display apparatus of claim 23, wherein the shutter controller closes the left eye shutter and opens the right eye shutter in the right eye image holding period and the left eye image scanning period, and opens the left eye shutter and closes the right eye shutter in the left eye image holding period and the right eye image scanning period.

26. The stereoscopic display apparatus of claim 24, further comprising a backlight unit which emits light to the display panel, wherein the backlight unit is turned on in the right eye image holding period and the left eye image holding period, and is turned off in other periods.

27. The stereoscopic display apparatus of claim 23, wherein the image signal input unit comprises a timing controller that transmits an gate timing control signal to the display panel.

28. The stereoscopic display apparatus of claim 23, wherein the image signal input unit modules a vertical sync signal in an image board and transmits a modulated vertical sync signal to a timing controller.

29. A method of driving a stereoscopic display apparatus, the method comprising:
scanning an image at a first frame frequency and a second frame frequency, which is different from the first frequency, using a display panel; and
selectively opening and closing a left eye shutter and a right eye shutter of shutter glasses, using a shutter controller.

30. The method of claim 29, wherein the first frame frequency is two to five times higher than the second frame frequency.

31. The method of claim 29, wherein the scanning the image comprises the display panel scanning a first left eye image frame, a second left eye image frame, a first right eye image frame, and a second right eye image frame, wherein the first left eye image frame and the first right eye image frame are scanned at the first frame frequency and the second left eye image frame and the fourth right eye image frame are scanned at the second frame frequency.

32. The method of claim 31, wherein the scanning the first left eye image frame and scanning the first right eye image frame each comprise simultaneously scanning two to five lines.

33. The method of claim 29, wherein the selectively opening and closing comprises opening the left eye shutter in a left eye effective period in which the first left eye image frame and the second left eye image frame are mixed with each other, and opening the right eye shutter in a right eye effective period in which the first right eye image frame and the second right eye image frame are mixed with each other.

34. The method of claim 33, wherein a portion of the left eye effective period comprising the second left eye image frame is larger than a portion of the left eye effective period comprising the first left eye image frame.

35. The method of claim 34, further comprising a backlight emitting light to the display panel, comprising:
turning on the backlight unit in the left eye effective period and in the right eye effective period.

36. The method of claim 30, wherein the first left eye image frame and the first right eye image frame are black.

37. The method of claim 36, wherein the selectively opening and closing comprises opening the left eye shutter in a left eye effective period in which the second left eye image frame and the first right eye image frame are mixed with each other, and opening the right eye shutter in a right eye effective period in which the second right eye image frame and the first left eye image frame are mixed with each other.

38. The method of claim 37, further comprising a backlight emitting light to the display panel, comprising:
turning on the backlight unit is turned in the left eye effective period and in the right eye effective period.

39. A method of driving a stereoscopic display apparatus, the method comprising:
sequentially scanning a first left eye image, a second left eye image, a first right eye image, and a second right eye image, using the display panel; and
closing a left eye shutter and a right eye shutter in periods in which a left eye image and a right eye image are mixed with each other, using a shutter controller.

40. The method of claim 39, wherein the second left eye image and the second right eye image are black.

41. The method of claim 40, further comprising the shutter controller opening the left eye shutter in periods in which the first left eye image is scanned and opening the right eye shutter in periods in which the first right eye image is scanned.

42. The method of claim 39, wherein, scanning each of the first left eye image, the second left eye image, the first right eye image, and the second right eye image comprises simultaneously scanning two to five lines.

43. The method of claim 39, further comprising the shutter controller opening the left eye shutter in periods in which the second left eye image is scanned and opening the right eye shutter in periods in which the second right eye image is scanned.

44. A method of driving a stereoscopic display apparatus comprising a display panel comprising a first region, the method comprising:
independently scanning the first region and the second region, comprising:
scanning a first left eye image period, holding the first left eye image in a first left eye image holding period, scanning a second left eye image period, and holding the second left eye image in a second left eye image holding period, in each of the first region and the second region;
scanning a first right eye image period, holding the first right eye image in a first right eye image holding period, scanning a second right eye image period, and holding the second right eye image in a second right eye image holding period, in each of the first region and the second region;
opening a left eye shutter in the first left eye image holding period, the second left eye image scanning period, and the second left eye image holding period, using a shutter controller; and
opening a right eye shutter in the first right eye image holding period, the second right eye image scanning period, and the second right eye image holding period, using the shutter controller.

45. The method of claim 44, further comprising emitting light to the display panel using a backlight unit, and
turning on the backlight unit is in the first left eye image holding period, the second left eye image scanning period, and the second left eye image holding period, the first right eye image holding period, the second right eye image scanning period, and the second right eye image holding period.

46. The method of claim 44, wherein a frame frequency of the first left eye image scanning period and the first left eye image holding period is an even-numbered multiple of 60 Hz.

47. The method of claim 44, wherein scanning of each of the first region and the second region comprises beginning scanning from an intermediate line of the display panel.

48. The method of claim 44, wherein scanning the first region and the second region comprises simultaneously scanning the first region and the second region.

49. A method for driving a stereoscopic display apparatus, the method comprising:
inputting a left eye image signal to a display panel, using an image signal input unit;
scanning a left eye image while holding a right eye image previously scanned by the display panel during inputting of the left eye image signal in a right eye image holding period;
inputting a right eye image signal to the display panel, using the image signal input unit;
scanning a right eye image period while holding the left eye image, using the display panel, during inputting of the right eye image signal in a left eye image holding period; and
selectively opening and closing a left eye shutter and a right eye shutter of shutter glasses, using a shutter controller.

50. The method of claim 49, wherein the selectively opening and closing comprises opening the right eye shutter in the right eye image holding period, and opening the left eye shutter in the left eye image holding period.

51. The method of claim 49, wherein the selectively opening and closing comprises closing the left eye shutter and opening the right eye shutter in the right eye image holding period and in the left eye image scanning period, and opening the left eye shutter and closing the right eye shutter in the left eye image holding period and in the right eye image scanning period.

52. The method of claim 50, further comprising emitting light to the display panel using a backlight unit, comprising turning on the backlight unit is in the right eye image holding period and in the left eye image holding period, and turning off the backlight unit in other periods.
